(19) United States
(12) Patent Application Publication
(10) Pub. No.: US 2008/0242746 A1
(43) Pub. Date: Oct. 2, 2008

(54) DISPERSION OF METAL OXIDE FINE PARTICLES AND METHOD FOR PRODUCING THE SAME

(75) Inventors: Kimiyasu MORIMURA, Kanagawa (JP); Yoshio Tadakuma, Kanagawa (JP); Yoichi Maruyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/054,639

(22) Filed: Mar. 25, 2008

(30) Foreign Application Priority Data
Mar. 29, 2007 (JP) 2007-086745

(51) Int. Cl. B01F 3/12

(52) U.S. Cl. 516/90; 516/88

(57) ABSTRACT

A dispersion of metal oxide fine particles, containing metal oxide fine particles, a strong acid and an aqueous solution, wherein the metal oxide fine particles and the strong acid are dispersed in an aqueous solution containing alcohol, and the dispersion of metal oxide fine particles has a light transmittance at 800 nm wavelength of 90% or more.

### BACKGROUND OF THE INVENTION

1. Field of the Invention

The present invention relates to a highly transparent dispersion of metal oxide fine particles in which metal oxide fine particles are dispersed with less aggregation, and a method for producing the dispersion of metal oxide fine particles.

2. Description of the Related Art

It is known that properties of metal oxide fine particles having a particle size of 100 nm or less are completely different from the properties of those having a particle size of more than 100 nm. Moreover, the metal oxide fine particles having a particle size of 100 nm or less are expected to have high catalytic property because a surface area per unit volume is extremely large, and a film is easily formed at a lower sintering temperature. Furthermore, they have high transparency in the visible range and a certain wavelength range, and can be widely used for optical filters, coatings, fibers, cosmetics or lenses.

In order to sufficiently exert these performances, the metal oxide fine particles are needed to be uniformly dispersed in a sol and base material without aggregation. However, the metal oxide fine particles having a large surface area per unit volume contribute to acceleration of aggregation, and the degree of aggregation is increased in accordance with increase of the concentration of a dispersion of metal oxide fine particles. Thus, there is a problem that sufficiently expected physical and optical performance may not be obtained.

Consequently, as a method for preventing aggregation in the dispersion of metal oxide fine particles, Japanese Patent Application Laid-Open (JP-A) No. 2004-59407 discloses in claims and examples use of a metal salt of aliphatic acid as a raw material of the metal oxide in metal oxide fine particles having improved cohesive property and the manufacturing method thereof. JP-A No. 2005-272244 discloses a method for synthesizing a solution of titanium dioxide nanoparticles, and in the paragraph [0012] discloses that a certain acid is coexisted. JP-A No. 2006-143535 discloses in the paragraph [0011] a zirconia sol having a uniform particle size distribution and excellent stability, a manufacturing method thereof, and addition of carboxylic acid and followed by hydrothermal process.

These related arts documents are effective in producing an aqueous dispersion of metal oxide fine particles, but not sufficient enough to obtain a highly transparent dispersion of metal oxide fine particles in which metal oxide fine particles are dispersed with less aggregation because a guideline for using alcohol to metal oxides is unclear and an acid used for hydrolysis is not appropriately selected. Therefore, further improvement and development are demanded in the current situation.

### BRIEF SUMMARY OF THE INVENTION

The present invention aims to solve the conventional problems and achieve the following objects. Specifically, an object of the present invention is to provide a highly transparent dispersion of metal oxide fine particles in which metal oxide fine particles are dispersed with less aggregation, and a method for producing the dispersion of metal oxide fine particles.

To solve the above problems, inventors of the present invention have conducted extensive studies to prevent unintentional aggregation of particles by interacting each other to form a large secondary aggregate particles in the dispersion of metal oxide fine particles that causes significant decrease of a sum of surface areas of all particles and impaired transparency. They found that by coexisting a metal alkoxide compound as a metal oxide precursor at hydrolysis, or coexisting a small amount of alcohol immediately after hydrolysis reaction, the metal oxide fine particles are highly dispersed so as to obtain a highly transparent dispersion of metal oxide fine particles with less aggregation. Moreover, they found that use of a strong acid that generates a specific bulky anion by dissociation allows to further increase effect.

The present invention is based on the above-mentioned findings by the inventors of the present invention and the means for solving the above-mentioned problems is as follows:
<1> A dispersion of metal oxide fine particles, containing metal oxide fine particles, a strong acid and an aqueous solution containing alcohol, wherein the metal oxide fine particles and the strong acid are dispersed in the aqueous solution containing alcohol, and the dispersion of metal oxide fine particles has a light transmittance at 800 nm wavelength of 90% or more.
<2> The dispersion of metal oxide fine particles according to <1>, wherein the dispersion of metal oxide fine particles has a light transmittance at 500 nm wavelength of 90% or more.
<3> The dispersion of metal oxide fine particles according to any of <1> and <2>, wherein the amount of the alcohol in the dispersion is 6 volume % to 60 volume %.
<4> The dispersion of metal oxide fine particles according to any of <1> to <3>, wherein the strong acid contains a bulky anion having B value of −0.01 or less in Equation (1):

η=η⁰(1+A√c+Bc) Equation (1)

where η represents a viscosity of a solution, η⁰ represents a viscosity of a solvent, A and B respectively represent constant values unique to an acid, and c represents a concentration of the solution.
<5> The dispersion of metal oxide fine particles according to <4>, wherein the bulky anion is at least one selected from Br⁻, I⁻, PF₆⁻, ClO₃⁻, NO₃⁻, ClO₄⁻ and IO₄⁻.
<6> The dispersion of metal oxide fine particles according to any of <1> to <5>, wherein the metal oxide fine particles, the strong acid and a carboxylic compound are dispersed in the aqueous solution containing alcohol.
<7> The dispersion of metal oxide fine particles according to any one of <1> to <6>, wherein the metal oxide fine particles have a volume-weighted average particle size of 1 nm to 50 nm.
<8> The dispersion of metal oxide fine particles according to any one of <1> to <7>, wherein a metal oxide constituting the metal oxide fine particles is any of a titanium oxide, a zirconium oxide, a composite oxide of titanium and zirconium, and a composite oxide of titanium, zirconium and hafnium.
<9> A method for producing a dispersion of metal oxide fine particles including mixing at least a metal oxide precursor and a strong acid in an aqueous solution containing alcohol so as to prepare metal oxide fine particles.
<10> The method for producing a dispersion of metal oxide fine particles according to <9>, wherein the metal oxide precursor contains any of an organic metal compound, a metal salt and a metal hydroxide.
<11> The method for producing a dispersion of metal oxide fine particles according to any of <9> and <10>, wherein the amount of the alcohol is 6 volume % to 60 volume %.

The present invention can solve the conventional problems and provide a highly transparent dispersion of metal oxide fine particles in which metal oxide fine particles are dispersed with less aggregation and a method for producing the dispersion of metal oxide fine particles.

### DETAILED DESCRIPTION OF THE INVENTION

### (Dispersion of Metal Oxide Fine Particles)

A dispersion of metal oxide fine particles of the present invention contains at least metal oxide fine particles and a strong acid which are dispersed in an aqueous solution containing alcohol, and contains a carboxylic compound, and further contains other components, if necessary.

The dispersion of metal oxide fine particles has a light transmittance at 800 nm wavelength of 90% or more, and preferably 95% or more.

The dispersion of metal oxide fine particles has a light transmittance at 500 nm wavelength of preferably 90% or more, and more preferably 95% or more.

The light transmittance is measured on a spectrophotometer U-3310 from Hitachi, Ltd, for example, in which distilled water used as a reference is poured into a quartz cell having an optical path length of 1 cm, and the dispersion of metal oxide fine particles is poured into the cell, and then measured for light transmittances at 800 nm and 500 nm wavelengths.

### <Metal Oxide Fine Particles>

A metal oxide contained in the metal oxide fine particles is not particularly limited, and may be appropriately selected depending on the purpose. Examples thereof include a titanium oxide, a zirconium oxide, a composite oxide of titanium and zirconium, a composite oxide of titanium, zirconium and hafnium, a composite oxide of titanium and barium, a composite oxide of titanium and aluminum, a composite oxide of titanium and silicon, a composite oxide of titanium, silicon and aluminum, a composite oxide of titanium, zirconium and aluminum, a composite oxide of titanium, zirconium and silicon, a composite oxide of titanium, zirconium, aluminum and silicon, a composite oxide of titanium and tin, and a composite oxide of titanium, zirconia and tin. Of these, a titanium oxide, a zirconium oxide, a composite oxide of titanium and zirconium, and a composite oxide of titanium, zirconia and hafnium are particularly preferred.

The metal oxide may contain other metallic elements as a dopant. The kinds and amount of the metallic element to be added may be appropriately selected depending on the purpose. For example, the titanium oxide fine particles can be doped with 0.1 atomic % to 20 atomic % of at least one metallic element selected from Fe, Co, Ni, Cu, Zn, Nb, Y, Rh, Pb, Ag, Ta, Pt and Au.

Moreover, the titanium oxide fine particles may be coated with at least one oxide or hydroxide of a metal selected from silicon, aluminum, zinc, tin and zirconia in terms of photocatalytic property (right resistance).

The metal oxide fine particles have an average particle size of preferably 1 nm to 50 nm, and more preferably 1 nm to 10 nm.

The volume-weighted average particle size of the metal oxide fine particles may be found by measuring a 4 mass % aqueous solution of metal oxide fine particles directly on a particle size distribution analyzer, Microtrac from NIKKISO Co., Ltd. Alternatively, an aqueous dispersion is dropped onto a carbon-deposited copper mesh (microgrid) and dried, and then observed by using a transmission electron microscope to obtain particle sizes. Specifically, a TEM image is exposed to a photo negative or taken into a recording medium (for example, hard disk, etc.) as a digital image, and then the image is printed large enough to observe particle sizes. The particle sizes can be obtained from the print. Because the TEM image is a two dimensional image, it is difficult to obtain a precise particle size, particularly in case of non-spherical particles. However, the particle sizes can be obtained using the diameter of circles that have the same area as projected areas of 300 or more particles as a two dimensional image (equivalent circular diameter).

The metal oxide fine particles may preferably contain crystalline metal oxide fine particles. The metal oxide fine particles are not necessarily crystalline, but preferably crystalline to exert physical and optical properties for the purpose of obtaining high catalytic property, low sintering temperature and high refractive index. For example, titanium dioxide preferably has an anatase or rutile structure.

Here, as a common method of confirming crystallinity of the metal oxide fine particles, X-ray diffraction spectrum method is used by cheking the peak of the crystals of the metal oxide fine particles for a match against a corresponding single crystal on RINT 1500 from Rigaku Corporation (X-ray source: copper Kα ray, wavelength: 1.5418 Å).

The dispersion of metal oxide fine particles is preferably a dilute solution containing less than 0.1 mass % of the metal oxide fine particles in terms of preventing aggregation thereof. In terms of dispersing the metal oxide fine particles in a sol or base material, a too much diluted solution may put a load in a subsequent concentrating step, thus the amount of the metal oxide fine particles in the dispersion is more preferably 0.1 mass % to 20 mass %.

### <Dispersing Solvent>

As a dispersing solvent, alcohol and water are used. Alcohol plays an particularly important role in hydrolysis of a metal alkoxide as a metal oxide precursor is started. Water is reacted after hydrolysis is started and serves as a dispersing medium of the metal oxide.

The amount of the alcohol in the dispersion is preferably 6 volume % to 60 volume % and more preferably 10 volume % to 50 volume %. When the amount of the alcohol is out of the above range, a dispersion may become gel, and does not work as a dispersion by particle aggregation, depending on a preparation condition.

The alcohol is preferably water miscible with lower alcohol. Examples thereof include methanol, ethanol, propanol, isopropanol, ethylene glycol, methoxyethanol, ethoxyethanol, methoxypropanol and ethoxypropanol. In addition, butanol may be used depending on applications. The alcohol preferably coexists in hydrolysis of a metal alkoxide, and preferably coexists after hydrolysis is started and before the metal oxide is dispersed in water.

The water is preferably deionized water free from inorganic ion. The amount of the water in the final dispersion differs depending on the kinds and sizes of produced metal oxide fine particles and cannot be generally defined, and it is preferably 40% or more contained in the volume of the final dispersion.

### <Strong Acid>

A strong acid is preferably used to promote hydrolysis reaction of the metal alkoxide as a metal oxide precursor. Examples thereof include nitric acid, perchloric acid, hydrochloric acid, HBr water, HI water, HPF₆, HClO₃ and HIO₄.

A strong acid that generates a bulky anion by dissociation is preferred, because it is very effective on increasing transparency of sol.

### Strong Acid Containing a Bulky Anion

The bulky anion contains fewer hydrated water molecules and may decrease the viscosity of the dispersion of metal oxide fine particles so as to suppress the aggregation of the metal oxide fine particles. When the amount of alcohol in a solvent is increased, a strong acid containing bulky structure is less effective on suppressing aggregation.

The acid compound containing a bulky anion contains an anion having B value of −0.01 or less in Equation (1) by Jones and Dole.

η=η⁰(1+A√c+Bc) Equation (1)

where η represents a viscosity of a solution, η⁰ represents a viscosity of a solvent, A and B respectively represent constant values unique to an acid, and c represents a concentration of the solution.

Here, B value relates to the degree of steric bulkiness of anion. The larger negative value the B value is, the more sterically-bulky the anion is (G. Jones and M. Dole, J. Am. Chem. Soc., 51 2950 (1929)). According to the HSAB theory, the acid compound becomes soft as the anion becomes sterically-bulky.

Examples of the bulky anions having the B value of −0.01 or less include Br⁻ (−0.042), I⁻ (−0.068), PF₆⁻ (−0.021), ClO₃⁻(−0.024), NO₃⁻ (−0.046), ClO₄⁻ (−0.056) and IO₄⁻ (−0.065). On the other hand, Cl⁻ (−0.007) and F⁻ (+0.096), which have the B value of more than −0.01, are not included in the bulky anion in the invention.

Examples of the acid compounds containing the bulky anion include HBr, HI, HPF₆, HCl₄, HClO₃, HNO₃, HIO₄ and salts thereof Examples of parts of the salts thereof include Li, Na, K, NH₄, NH₃CH₂CH₂OH, NH₂(CH₂CH₂OH)₂ and NH(CH₂CH₂OH)₃.

The amount of the strong acid in the dispersion of metal oxide fine particles differs depending on kinds and sizes of produced metal oxide fine particles and cannot be generally defined, and it is preferably 0.1 mole to 1 mole, and more preferably 0.2 mole to 0.9 mole per 1 mole of metal.

### <Carboxylic Compound>

The dispersion of metal oxide fine particles of the present invention preferably contains a carboxylic compound for the purpose of improving disperisibility of particles. As the carboxylic compound, at least one selected from carboxylic acids, salts of carboxylic acids and carboxylic anhydrides are used.

### Carboxylic Acid

The carboxylic acid is not particularly limited, and may be appropriately selected depending on the purpose. Examples thereof include saturated aliphatic carboxylic acids such as formic acid, acetic acid, propionic acid, butyric acid, isobutyric acid, valeric acid, isovaleric acid, pivalic acid, caproic acid, caprylic acid, capric acid, malonic acid, succinic acid, glutaric acid, adipic acid, pimelic acid and suberic acid; unsaturated aliphatic carboxylic acids such as acrylic acid, propiolic acid, methacrylic acid, crotonic acid, isocrotonic acid, maleic acid and fumaric acid; hydroxy carboxylic acids such as lactic acid, tartaric acid, malic acid and citric acid. These may be used alone or in combination.

The amount of the carboxylic acid in the dispersion of metal oxide fine particles differs depending on the kinds or sizes of produced metal oxide fine particles and cannot be generally defined, and it is preferably 0.15 mole to 3 mole per 1 mole of metal.

### Salt of Carboxylic Acid

By dissociation of salt, the salts of carboxylic acids substantially show the same effect as corresponding carboxylic acids.

Examples of the carboxylic acids in the salts of carboxylic acids include those described in the carboxylic acids.

In the salts of carboxylic acids, examples of parts other than the carboxylic acid include Li, Na, K, NH₄, NH₃CH₂CH₂OH, NH₂(CH₂CH₂OH)₂ and NH(CH₂CH₂OH)₃.

The amount of the salt of carboxylic acid in the dispersion of metal oxide fine particles differs depending on kinds or sizes of produced metal oxide fine particles and cannot be generally defined, and it is preferably 0.15 mole to 3 mole per 1 mole of metal.

### Carboxylic Anhydride

In an aqueous solution, the carboxylic anhydride, in which 2 molecules of carboxylic acid are condensed by losing one molecule of water, substantially shows the same effect as corresponding carboxylic acids.

The carboxylic anhydride is not particularly limited and may be appropriately selected depending on the purpose. Examples of the carboxylic anhydrides include acetic anhydrides, propionic anhydrides, succinic anhydrides, maleic anhydrides and phthalic anhydrides. These may be used alone or in combination.

The amount of the carboxylic anhydride in the dispersion of metal oxide fine particles differs depending on kinds and sizes of produced metal oxide fine particles and cannot be generally defined, and it is preferably 0.075 mole to 1.5 mole per 1 mole of metal.

### (Method for Producing a Dispersion of Metal Oxide Fine Particles)

A method for producing a dispersion of metal oxide fine particles of the present invention includes a step of preparing metal oxide fine particles and further includes other steps, if necessary.

### <Step of Preparing Metal Oxide Fine Particles>

The step of preparing metal oxide fine particles is a step in which at least a metal oxide precursor and strong acid, and optionally a carboxylic compound as necessary are mixed in an aqueous solution containing alcohol to prepare metal oxide fine particles.

The metal alkoxide as the metal oxide precursor and the strong acid are reacted to start hydrolysis reaction. Alcohol may be preliminarily mixed with either a metal alkoxide or strong acid, or mixed immediately after hydrolysis reaction is started, and the alcohol is preferably coexisted in a system in which the metal alkoxide is hydrolyzed. A strong acid that generates a bulky anion by dissociation is preferred is preferred.

As the alcohol, strong acid and carboxylic compound, any one appropriately selected from those described above may be used.

The amount of the alcohol is preferably 6 volume % to 60 volume % and more preferably 10 volume % to 50 volume % relative to a dispersion.

The metal oxide precursor preferably contains, for example, any of an organic metal compound, a metal salt and a metal hydroxide.

The metal oxide precursor may be solid or liquid, and preferably water soluble and treated as an aqueous solution.

The metal component of the metal salt is a metal component of a corresponding metal oxide.

Examples of the metal salts include chlorides, bromides, iodides, nitrates, sulfates and organic acid salt of desired metals. Examples of the organic acid salts include acetate, propionate, naphthenate, octoate, stearate and oleate.

Examples of the metal hydroxides include amorphous titanium hydroxides in which a titanium tetrachloride solution is neutralized with an alkaline solution, zirconium hydroxides, and a composite hydroxide of titanium and zirconium.

Examples of the organic metal compounds include metal alkoxide compounds and metal acetylacetonate compounds.

Examples of the metal alkoxide compounds include tetraalkoxytitaniums and alkoxyzirconiums.

Examples of tetraalkoxytitaniums include tetramethoxytitanium, tetraethoxytitanium, tetrapropoxytitanium, tetraisopropoxytitanium, tetrabutoxytitanium, tetraisobutoxytitanium, tetrakis(2-methylpropoxy)titanium, tetrakis pentoxy titanium, tetrakis(2-ethylbutoxy)titanium, tetrakis(octoxy)titanium and tetrakis(2-ethylhexoxy)titanium. The tetraalkoxytitanium having too many number of carbon atoms in an alkoxyl group may not sufficiently undergo hydrolysis. The tetraalkoxytitanium having too small number of carbon atoms in an alkoxyl group may have high reactivity and be difficult to control reaction. Therefore, tetrapropoxytitanium and tetraisopropoxytitanium are particularly preferred.

Examples of alkoxyzirconiums include methoxyzirconium, ethoxyzirconium, propoxyzirconium, buthoxyzirconium, isobuthoxyzirconium and kis(2-methylpropoxy)zirconium. Of these, buthoxyzirconium is particularly preferred.

As the metal alkoxide compounds other than titanium and zirconium, metals in the metal alkoxide compounds are preferably hafnium, aluminum, silicon, barium, tin, magnesium, calcium, iron, bismuth, gallium, germanium, indium, molybdenum, niobium, lead, antimony, strontium, tungsten and yttria. The alkoxides of these metals can be produced by reacting a metal alkoxide such as potassium alkoxide or sodium alkoxide with a desired metal, as necessary.

Examples of the metal salts include chlorides, bromides, iodides, nitrates, sulfates and organic acid salt of desired metals. Examples of the organic acid salts include acetate, propionate, naphthenate, octoate, stearate and oleate.

Examples of the metal hydroxides include amorphous titanium hydroxides in which a titanium tetrachloride solution is neutralized with an alkaline solution, zirconium hydroxides, and a composite hydroxide of titanium and zirconium.

The method for producing a dispersion of metal oxide fine particles of the present invention specifically includes the following embodiments:

(1) A metal alkoxide compound is mixed in alcohol at room temperature and stirred for 10 minutes. And then a strong acid is added therein and stirred for 10 minutes, a large amount of water is acted on the metal alkoxide compound, and then the heat treatment is performed to produce a dispersion of metal oxide fine particles.

A method for producing a dispersion of metal oxide fine particles (1′) described below, in which the timing of addition of the strong acid in (1) is changed, is also preferably used:

(1′) A strong acid is added in alcohol at room temperature and stirred for 10 minutes. And then, a metal alkoxide compound is added therein and stirred for 10 minutes, reacted with a large amount of water and appropriately subjected to heat treatment to produce a dispersion of metal oxide fine particles.

A method for producing an aqueous dispersion of metal oxide fine particles (1″) described below, in which at first alcohol is not coexisted in (1), is also preferably used:

(1″) A strong acid is added in a metal alkoxide compound at room temperature and stirred for 10 minutes. And then, alcohol is added therein and stirred for 10 minutes, a large amount of water is acted on the metal alkoxide compound, and then the heat treatment is performed to produce a dispersion of metal oxide fine particles.

In (1), (1′) and (1″), examples of titanium oxides as the metal alkoxides include titanium tetraisopropoxide, titanium tetrabutoxide and titanium tetraproxide. Examples of zirconium oxides include zirconium tetrabutoxide, zirconium tetra-tert-butoxide, zirconium diethoxide and zirconium tetraisopropoxide.

As the alcohol and strong acid, any one appropriately selected from those described above may be used. Examples of the alcohol include methanol, ethanol, propanol, isopropanol, ethoxy methanol, ethoxy ethanol and ethoxy propanol. Examples of the strong acid include nitric acid, perchloric acid, hydrochloric acid, sulfuric acid and phosphoric acid. Of these, nitric acid and perchloric acid, which contain an anion generated by dissociation of a strong acid having a bulky structure, are preferred.

The washing method is not particularly limited and those known methods may be used as long as excess ions can be removed. Examples thereof include an ultrafiltration membrane method, a filtration separation method, a centrifugal separation-filtration method and an ion-exchange resin method.

### <Applications>

The dispersion of metal oxide fine particles of the present invention can be used as it is or condensed to be used as a dispersion. In addition, a binder component (resin component) is added to the dispersion of metal oxide fine particles to prepare a composition for film deposition (coating composition), and it is coated on a base material to form a fine particle dispersed film. Alternatively the dispersion of metal oxide fine particles is contained in a binder component (resin component) so as to prepare a resin composition for molding. Moreover, the dispersion of metal oxide fine particles is also prepared as a powder of fine particles by removing a solvent by concentration and drying, or centrifugation, and then by heating and drying.

The binder component is not particularly limited and may be appropriately selected depending on the purpose. Examples thereof include various kinds of synthetic resins such as thermoplastic or thermosetting resins (including thermosetting, ultraviolet curable, electron beam curable and moisture-curable resins, and combinations thereof), for example, silicon alkoxide binders, acrylic resins, polyester resins, fluorine resins, and organic binders such as natural resins. Examples of the synthetic resins include alkyd resins, amino resins, vinyl resins, acrylic resins, epoxy resins, polyamide resins, polyurethane resins, thermosetting unsaturated polyester resins, phenol resins, chlorinated polyolefin resins, silicone resins, acrylic silicone resins, fluorine resins, xylene resins, petroleum resins, ketone resins, rosin-modified maleic resins, liquid polybutadienes and coumarone resins. Examples of the natural resins include shellacs, rosins (pine resins), ester gums, hardened rosins, decolored shellacs and white shellacs. These may be used alone or in combination.

When the metal oxide fine particles are dispersed in a resin composition, the metal oxide fine particles are formulated with a dispersant, oil component, surfactant, pigment, preservative, alcohol, water, thickener or humectant, and used in various forms such as a dilute solution, tablet, lotion, cream, paste or stick, if necessary. The dispersant is not particularly limited and may be appropriately selected depending on the purpose. Examples thereof include a compound having a phosphoric acid group, a polymer having a phosphoric acid group, a silane coupling agent and a titanium coupling agent.

The dispersion of metal oxide fine particles of the present invention may be preferably used for optical filters, coatings, fibers, cosmetics, lenses or the like, because it has excellent dispersion stability and high transparency in the visible range and a certain wavelength range.

### EXAMPLES

Examples of the present invention will be described below, however, the present invention is not limited in scope to these Examples at all.

### Example 1

### Production of Dispersions A-1 to A-18

According to the description of Table 1, a strong acid was mixed with water or alcohol and stirred for 10 minutes, and then 14 cc of titanium tetraisopropoxide (from Wako Pure Chemical Industries, Ltd.) was added therein and stirred for 10 minutes at room temperature (23° C.). The mixture was mixed with hot water which had been preliminarily kept at 80° C. in a water bath and stirred for 5 minutes, and acetic acid was added as necessary, and then cooled to room temperature to obtain respective dispersions. Table 1 shows the kinds and amounts of alcohols, ratios of the alcohols in the dispersions, the kinds and amounts of strong acids, and amounts of the acetic acids to be added.

Moreover, Table 1 shows respective results of an average size of 150 titanium oxide ultrafine particles found by TEM observation, and a transmittance at 800 nm wavelength of 4 mass % of the dispersions (optical path length of 1 cm).

The obtained dispersions of titanium oxide fine particles were respectively air dried to obtain titanium oxide fine particles.

The crystallinity, volume-weighted average particle size and light transmittance of the respective titanium oxide fine particles were measured as described below. The results are shown in Table 1.

### <Measurement of X-Ray Diffraction (XRD) Spectrum>

The obtained titanium oxide fine particles were respectively measured at 23° C. on RINT 1500 from Rigaku Corporation (X-ray source: copper Kα ray, wavelength: 1.5418 Å) to obtain X-ray diffraction (XRD) spectra. All of them were anatase titanium oxides (crystallinity).

### <Measurement of Volume-Weighted Average Particle Size>

The dispersion to be measured was dropped onto a carbon-deposited copper mesh (microgrid) and dried, and then observed at 5 fields of views or more at a magnification of ×25,000 by using a transmission electron microscope H-9000 UHR Model from Hitachi, Ltd. (accelerating voltage: 200 kV, degree of vacuum in observation: about 7.6×10⁻⁹ Pa) to obtain a volume-weighted average particle size of 150 titanium oxide fine particles.

### <Measurement of Light Transmittance>

Each of the light transmittance of the obtained titanium oxide fine particles was measured on a spectrophotometer U-3310 from Hitachi, Ltd., in which distilled water as a reference was poured into a quartz cell having an optical path length of 1 cm, and the dispersions containing 4 mass % of the obtained titanium oxide fine particles was poured into the cell, and then measured for light transmittances at 800 nm and 500 nm wavelengths.

TABLE 1

| | | | | | B Value | Amount | | |
|---|---|---|---|---|---|---|---|---|
| | | | Ratio | Kind | of | of strong | | |
| | Water or alcohol | | of | of | strong | acid | Carboxylic acid | |
| | | Amount | alcohol | strong | acid | (mol fr.) | | Amount |
| Dispersion | Kind | (cc) | (%) | acid | (*1) | (*2) | Kind | (cc) |
| A-1 | water | 24 | 0 | HCl | −0.007 | 0.79 | — | — |
| A-2 | water | 24 | 0 | HCl | −0.007 | 0.79 | acetic acid | 5 |
| A-3 | methanol | 24 | 23 | HCl | −0.007 | 0.79 | — | — |
| A-4 | ethanol | 24 | 23 | HCl | −0.007 | 0.79 | — | — |
| A-5 | propanol | 24 | 23 | HCl | −0.007 | 0.79 | — | — |
| A-6 | isopropanol | 24 | 23 | HCl | −0.007 | 0.79 | — | — |
| A-7 | isopropanol | 24 | 23 | HCl | −0.007 | 0.79 | acetic acid | 5 |
| A-8 | isopropanol | 12 | 12 | HCl | −0.007 | 0.79 | — | — |
| A-9 | isopropanol | 6 | 6 | HCl | −0.007 | 0.79 | — | — |
| A-10 | none | 0 | 0 | HCl | −0.007 | 0.79 | — | — |
| A-11 | isopropanol | 48 | 46 | HCl | −0.007 | 0.79 | — | — |
| A-12 | isopropanol | 60 | 58 | HCl | −0.007 | 0.79 | — | — |
| A-13 | isopropanol | 72 | 69 | HCl | −0.007 | 0.79 | — | — |
| A-14 | isopropanol | 84 | 81 | HCl | −0.007 | 0.79 | — | — |
| A-15 | isopropanol | 24 | 23 | HNO₃ | −0.046 | 0.79 | acetic acid | 5 |
| A-16 | isopropanol | 24 | 23 | HClO₄ | −0.056 | 0.79 | acetic acid | 5 |
| A-17 | isopropanol | 24 | 23 | HPF₆ | −0.021 | 0.79 | acetic acid | 5 |
| A-18 | isopropanol | 24 | 23 | HIO₄ | −0.065 | 0.79 | acetic acid | 5 |

| | Amount | Average | Transmittance | Transmittance | |
|---|---|---|---|---|---|
| | of hot | particle | at 800 nm | at 500 nm | |
| | water | size | wavelength | wavelength | |
| Dispersion | (cc) | (nm) | (%) | (%) | |
| A-1 | 62 | 41 | 86.4 | 30.1 | Comparative |
| | | | | | Example |
| A-2 | 57 | 30 | 89.9 | 57 | Comparative |
| | | | | | Example |
| A-3 | 62 | 4 | 99.9 | 97 | Example |
| A-4 | 62 | 4.2 | 99.1 | 95.5 | Example |
| A-5 | 62 | 4.1 | 99.2 | 96.2 | Example |
| A-6 | 62 | 4.2 | 99.2 | 95.9 | Example |
| A-7 | 57 | 4 | 99.6 | 97 | Example |
| A-8 | 74 | 6 | 99.1 | 90.3 | Example |
| A-9 | 80 | 8 | 97.4 | 78.5 | Example |
| A-10 | 86 | 62 | 80.7 | 24.7 | Comparative |
| | | | | | Example |
| A-11 | 38 | 3.8 | 99.7 | 97.2 | Example |
| A-12 | 26 | 20 | 92.3 | 51.6 | Example |
| A-13 | 14 | — | gel | gel | Comparative |
| | | | | | Example |
| A-14 | 2 | — | gel | gel | Comparative |
| | | | | | Example |
| A-15 | 57 | 4 | 99.5 | 96.7 | Example |
| A-16 | 57 | 3.7 | 99.9 | 98.2 | Example |
| A-17 | 57 | 4.1 | 99.5 | 96.7 | Example |
| A-18 | 57 | 3.6 | 100 | 98.3 | Example |

(*1) B value: G. Jones and M. Dole, J. Am. Chem. Soc., 51 2950 (1929)
(*2) The amount of the strong acid (mol fr.) represents the amount of the strong acid (mole) added relative to the amount of the titanium (mole).

As is clear from the results of Table 1, the dispersions A-3 to A-9, A-11 to A-12 and A-15 to A-18 of the present invention were found to have a small average particle size, high transparency and an extremely high practical use.

### Example 2

### Production of Dispersions B-1 to B-15

According to the description of Table 2, a strong acid was mixed with isopropanol and stirred for 10 minutes, and then 14 cc of titanium tetraisopropoxide (from Wako Pure Chemical Industries, Ltd.) was mixed therein and stirred for 10 minutes at room temperature (22° C.). The mixture was mixed with hot water which had been preliminarily kept at 80° C. in a water bath and carboxylic acid was appropriately added, 1.6 g of zirconium oxychloride was added as necessary, and stirred for 2 hours, and then cooled to room temperature to obtain respective dispersions. Table 2 shows the kinds and amounts of alcohols, ratios of the alcohols in the dispersions, the kinds and amounts of strong acids, and amounts of the carboxylic compounds relative to titanium (mol fr.).

The obtained dispersions of titanium oxide fine particles were respectively air dried to obtain titanium oxide fine particles (or a composite oxide of titanium and zirconium).

The crystallinity, volume-weighted average particle size and light transmittance of the respective titanium oxide fine particles (or a composite oxide of titanium and zirconium) were measured as described below. The results are shown in Table 2.

### <Measurement of X-Ray Diffraction (XRD) Spectrum>

The obtained titanium oxide fine particles (or a composite oxide of titanium and zirconium) were respectively measured at 23° C. on RINT 1500 from Rigaku Corporation (X-ray source: copper Kα ray, wavelength: 1.5418 Å) to obtain X-ray diffraction (XRD) spectra. All of them were anatase titanium oxides (crystallinity).

### <Measurement of Volume-Weighted Average Particle Size>

The dispersion to be measured was dropped onto a carbon-deposited copper mesh (microgrid) and dried, and then observed at 5 fields of views or more at a magnification of ×25,000 by using a transmission electron microscope H-9000 UHR Model from Hitachi, Ltd. (accelerating voltage: 200 kV, degree of vacuum in observation: about 7.6×10⁻⁹ Pa) to obtain a volume-weighted average particle size of 150 titanium oxide fine particles (or a composite oxide of titanium and zirconium).

### <Measurement of Light Transmittance>

Each of the light transmittance of the obtained titanium oxide fine particles was measured on a spectrophotometer U-3310 from Hitachi, Ltd., in which distilled water as a reference was poured into a quartz cell having an optical path length of 1 cm, and the dispersions containing 4 mass % of the obtained titanium oxide fine particles (or a composite oxide of titanium and zirconium) was poured into the cell, and then measured for light transmittances at 800 nm and 500 nm wavelengths.

TABLE 2

| | Alcohol | | | | Strong acid | | | Carboxylic acid | |
|---|---|---|---|---|---|---|---|---|---|
| | | Amount | ratio | | | B | Amount | | Amount |
| Dispersion | Kind | (cc) | (%) | Zirconium | Kind | Value (*1) | (mol fr.) (*2) | Kind | (mol fr.) (*3) |
| B-1 | isopropanol | 24 | 23 | Absence | HCl | −0.007 | 1.2 | acetic acid | 1 |
| B-2 | isopropanol | 24 | 23 | Absence | HClO₄ | −0.056 | 1.2 | acetic acid | 1 |
| B-3 | isopropanol | 24 | 23 | Absence | HClO₄ | −0.056 | 1.2 | propionic acid | 1 |
| B-4 | isopropanol | 24 | 23 | Presence | HCl | −0.007 | 1.2 | acetic acid | 1 |
| B-5 | isopropanol | 24 | 23 | Presence | HClO₄ | −0.056 | 1.2 | acetic acid | 1 |
| B-6 | isopropanol | 24 | 23 | Presence | HClO₄ | −0.056 | 1.2 | propionic acid | 1 |
| B-7 | isopropanol | 24 | 23 | Presence | HClO₄ | −0.056 | 1.2 | citric acid | 1 |
| B-8 | isopropanol | 24 | 23 | Presence | HClO₄ | −0.056 | 1.2 | acetic anhydride | 0.5 |
| B-9 | isopropanol | 24 | 23 | Presence | HClO₄ | −0.056 | 1.2 | acetic anhydride | 1 |
| B-10 | None | 0 | 0 | Presence | HClO₄ | −0.056 | 1.2 | — | 0 |
| B-11 | isopropanol | 3 | 3 | Presence | HClO₄ | −0.056 | 1.2 | — | 0 |
| B-12 | isopropanol | 6 | 6 | Presence | HClO₄ | −0.056 | 1.2 | — | 0 |
| B-13 | isopropanol | 24 | 23 | Presence | HClO₄ | −0.056 | 1.2 | — | 0 |
| B-14 | isopropanol | 24 | 60 | Presence | HClO₄ | −0.056 | 1.2 | — | 0 |
| B-15 | isopropanol | 24 | 65 | Presence | HClO₄ | −0.056 | 1.2 | — | 0 |

| | Amount | Average | Transmittance | Transmittance | |
|---|---|---|---|---|---|
| | of hot | particle | at 800 nm | at 500 nm | |
| | water | size | wavelength | wavelength | |
| Dispersion | (cc) | (nm) | (%) | (%) | |
| B-1 | 56 | 4.2 | 99.2 | 95.6 | Example |
| B-2 | 56 | 4 | 99.6 | 97 | Example |
| B-3 | 56 | 4 | 99.8 | 97.2 | Example |
| B-4 | 56 | 4.5 | 99 | 94.8 | Example |
| B-5 | 56 | 4 | 99.6 | 97 | Example |
| B-6 | 56 | 4.1 | 99.1 | 96.1 | Example |
| B-7 | 56 | 4.1 | 99 | 96.2 | Example |
| B-8 | 59 | 4 | 99.5 | 96.9 | Example |
| B-9 | 56 | 4.1 | 99.1 | 96.2 | Example |
| B-10 | 61 | 52 | 85.2 | 28.5 | Comparative |
| | | | | | Example |
| B-11 | 61 | 18 | 91.2 | 50.3 | Example |
| B-12 | 61 | 12 | 94.6 | 54.1 | Example |
| B-13 | 61 | 5 | 99.3 | 93.5 | Example |
| B-14 | 61 | 25 | 90.5 | 49.3 | Example |
| B-15 | 61 | — | gel | gel | Comparative |
| | | | | | Example |

(*1) B value: G. Jones and M. Dole, J. Am. Chem. Soc., 51 2950 (1929)
(*2) The amount of the strong acid (mol fr.) represents the amount of the strong acid (mole) added relative to the amount of the titanium (mole).
(*3) The amount of the carboxylic acid (mol fr.) represents the amount of the carboxylic acid (mole) added relative to the amount of the titanium (mole).

As is clear from the results of Table 2, the dispersions B-1 to B-9 and B-11 to B-14 of the present invention were found to have a small average particle size, high transparency and an extremely high practical use.

The dispersion of metal oxide fine particles of the present invention can be widely used as a very useful material for optical filters, coatings, fibers, cosmetics, lenses or the like, because they have high transparency in the visible range and a certain wavelength range.

What is claimed is:

1. A dispersion of metal oxide fine particles, comprising:
metal oxide fine particles;
a strong acid; and
an aqueous solution containing alcohol,
wherein the metal oxide fine particles and the strong acid are dispersed in the aqueous solution containing alcohol, and the dispersion of metal oxide fine particles has a light transmittance at 800 nm wavelength of 90% or more.

2. The dispersion of metal oxide fine particles according to claim 1, wherein the dispersion of metal oxide fine particles has a light transmittance at 500 nm wavelength of 90% or more.

3. The dispersion of metal oxide fine particles according to claim 1, wherein the amount of the alcohol in the dispersion is 6 volume % to 60 volume %.

4. The dispersion of metal oxide fine particles according to claim 1, wherein the strong acid comprises a bulky anion having B value of −0.01 or less in Equation (1):
η=η⁰(1+A√c+Bc) Equation (1)
where η represents a viscosity of a solution, η⁰ represents a viscosity of a solvent, A and B respectively represent constant values unique to an acid, and c represents a concentration of the solution.

5. The dispersion of metal oxide fine particles according to claim 4, wherein the bulky anion is at least one selected from Br⁻, I⁻, PF₆⁻, ClO₃⁻, NO₃⁻, ClO₄⁻ and IO₄⁻.

6. The dispersion of metal oxide fine particles according to claim 1, wherein the metal oxide fine particles, the strong acid and a carboxylic compound are dispersed in the aqueous solution containing alcohol.

7. The dispersion of metal oxide fine particles according to claim 1, wherein the metal oxide fine particles have a volume-weighted average particle size of 1 nm to 50 nm.

8. The dispersion of metal oxide fine particles according to claim 1, wherein a metal oxide constituting the metal oxide fine particles is any of a titanium oxide, a zirconium oxide, a composite oxide of titanium and zirconium, and a composite oxide of titanium, zirconium and hafnium.

9. A method for producing a dispersion of metal oxide fine particles comprising:
mixing at least a metal oxide precursor and a strong acid in an aqueous solution containing alcohol so as to prepare metal oxide fine particles.

10. The method for producing a dispersion of metal oxide fine particles according to claim 9, wherein the metal oxide precursor comprises any of an organic metal compound, a metal salt and a metal hydroxide.

11. The method for producing a dispersion of metal oxide fine particles according to claim 9, wherein the amount of the alcohol is 6 volume % to 60 volume %.
